(19) United States
(12) Patent Application Publication
(10) Pub. No.: US 2020/0167600 A1
(43) Pub. Date: May 28, 2020

(54) INFORMATION PROCESSING SYSTEM, NON-TRANSITORY COMPUTER READABLE MEDIUM, AND INFORMATION PROCESSING METHOD

(71) Applicant: FUJI XEROX CO., LTD., Tokyo (JP)

(72) Inventors: Tadao MICHIMURA, Kanagawa (JP); Yoshihiro HASHIMOTO, Kanagawa (JP); Takeshi FURUYA, Kanagawa (JP); Kiyotaka TSUCHIBUCHI, Kanagawa (JP)

(73) Assignee: FUJI XEROX CO., LTD., Tokyo (JP)

(21) Appl. No.: 16/381,079

(22) Filed: Apr. 11, 2019

(30) Foreign Application Priority Data
Nov. 22, 2018 (JP) 2018-219490

(51) Int. Cl. G06K 9/62; G06N 5/04; G06F 17/28; G06F 3/0482; H04L 12/18; H04L 29/06

(52) U.S. Cl. CPC G06K 9/6219; G06N 5/04; G06F 17/2818; G06K 9/6298; H04L 12/1822; H04L 29/06414; G06F 3/0482

(57) ABSTRACT

An information processing system includes a positioning information obtainer, a level-of-importance obtainer, a degree-of-agreement obtainer, and a calculator. The positioning information obtainer obtains information on positions of statements in an argument. The level-of-importance obtainer obtains levels of importance of the statements for a claim in the argument in accordance with the positions of the statements. The degree-of-agreement obtainer obtains a degree of agreement indicating a degree to which participants in the argument agree on each of the statements. The calculator calculates a degree of claim agreement of the claim and a degree of claim certainty of the claim from the levels of importance and the degrees of agreement on the statements. The degree of claim agreement indicates a degree to which the participants in the argument agree on the claim. The degree of claim certainty indicates a degree of certainty of the claim.

### CROSS-REFERENCE TO RELATED APPLICATIONS

This application is based on and claims priority under 35 USC 119 from Japanese Patent Application No. 2018-219490 filed Nov. 22, 2018.

### BACKGROUND

### (i) Technical Field

The present disclosure relates to an information processing system, a non-transitory computer readable medium, and an information processing method.

### (ii) Related Art

Statements made during an argument are analyzed to support in reaching an agreement. Japanese Unexamined Patent Application Publication No. 2004-200741 discloses a system for logically and quantitatively conducting relative comprehensive evaluations of opposing claims during an argument in terms of reliability. In the disclosed system, grounds and reasons for each claim are substantiated and developed along a hierarchical reasoning structure, and the degree of reliability of the claim is calculated based on the numerical evaluation of the reliability of the grounds and reasons at the bottom.

### SUMMARY

To support in reaching an agreement in an argument, the positions of statements made in connection with a claim in the argument are determined, and how the statements are each supported by participants in the argument is clarified.

Aspects of non-limiting embodiments of the present disclosure relate to a system that, instead of merely examining the reliability of a claim in an argument, clarifies the positions of statements made in the argument and supports in reaching an agreement in the argument.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a positioning information obtainer, a level-of-importance obtainer, a degree-of-agreement obtainer, and a calculator. The positioning information obtainer obtains information on positions of statements in an argument. The level-of-importance obtainer obtains levels of importance of the statements for a claim in the argument in accordance with the positions of the statements. The degree-of-agreement obtainer obtains a degree of agreement indicating a degree to which participants in the argument agree on each of the statements. The calculator calculates a degree of claim agreement of the claim and a degree of claim certainty of the claim from the levels of importance and the degrees of agreement on the statements. The degree of claim agreement indicates a degree to which the participants in the argument agree on the claim. The degree of claim certainty indicates a degree of certainty of the claim.

### BRIEF DESCRIPTION OF THE DRAWINGS

An exemplary embodiment of the present disclosure will be described in detail based on the following figures, wherein:

FIG. 1 illustrates an overall configuration of a conference support system to which this exemplary embodiment is applied;

FIG. 2 illustrates a functional configuration of a conference support server;

FIG. 3 illustrates a functional configuration of a participant terminal;

FIG. 4 illustrates a functional configuration of an administrator terminal;

FIG. 5 illustrates the structure of the Toulmin model;

FIG. 6 illustrates an example of analysis of an argument for and against a certain “claim” using the Toulmin model;

FIG. 7 illustrates characteristic values set for statements in the argument illustrated in FIG. 6;

FIG. 8 illustrates characteristic values set for statements in the argument illustrated in FIG. 6;

FIG. 9 illustrates an example of displayed processing results of the conference support server;

FIGS. 10A to 10C illustrate example screens that display the processing results of the conference support server such that categories are displayed in different display styles in accordance with claim characteristic values and characteristic values, in which FIG. 10A illustrates an example display screen when the claim characteristic values are less than a first threshold value, FIG. 10B illustrates an example display screen when the claim characteristic values are greater than or equal to the first threshold value and less than a second threshold value, and FIG. 10C illustrates an example display screen when the claim characteristic values are greater than or equal to the second threshold value;

FIG. 11 illustrates an example display screen that presents hierarchies of arguments;

FIGS. 12A and 12B illustrate an example of characteristic values and claim characteristic values of statements and their materials made for and against a certain claim, in which FIG. 12A illustrates an example argument for and against a certain claim, and FIG. 12B illustrates an example of characteristic values of statements and their materials in the argument illustrated in FIG. 12A;

FIGS. 13A and 13B illustrate an example change in characteristic value and claim characteristic value when a new statement and its materials are further presented in the situation illustrated in FIGS. 12A and 12B, in which FIG. 13A illustrates a situation in which a new statement and its materials are presented in the situation illustrated in FIG. 12A, and FIG. 13B illustrates an example of characteristic values of statements and their materials in the argument illustrated in FIG. 13A;

FIG. 14 is a flowchart illustrating the operation of the conference support server according to this exemplary embodiment; and

FIG. 15 illustrates an example of an argument model based on dialectics.

### DETAILED DESCRIPTION

The following describes an exemplary embodiment of the present disclosure in detail with reference to the accompanying drawings.

### System Configuration

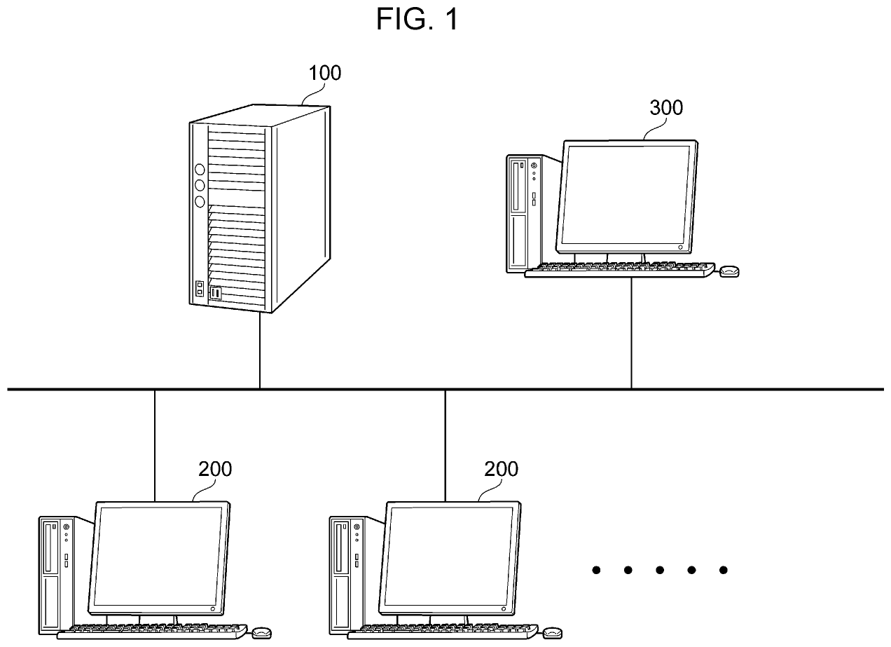

FIG. 1 illustrates an overall configuration of a conference support system according to this exemplary embodiment. The conference support system includes a conference support server 100, participant terminals 200, and an administrator terminal 300. The conference support server 100 is a server that analyzes statements of participants in a conference. The conference support server 100 is an example of an information processing system. Each of the participant terminals 200 is an information terminal apparatus that a conference participant uses to input information on statements in the conference or to view information on the conference. The information on the conference is provided from the conference support server 100. In each conference to be supported, a number of participant terminals 200 equal to the number of participants in the conference are connected. The administrator terminal 300 is an information terminal apparatus used by a person who has the privilege of hosting the conference, such as a conference facilitator. The conference support server 100, the participant terminals 200, and the administrator terminal 300 are connected to one another via a network such as a local area network (LAN).

### Functional Configuration of Conference Support Server

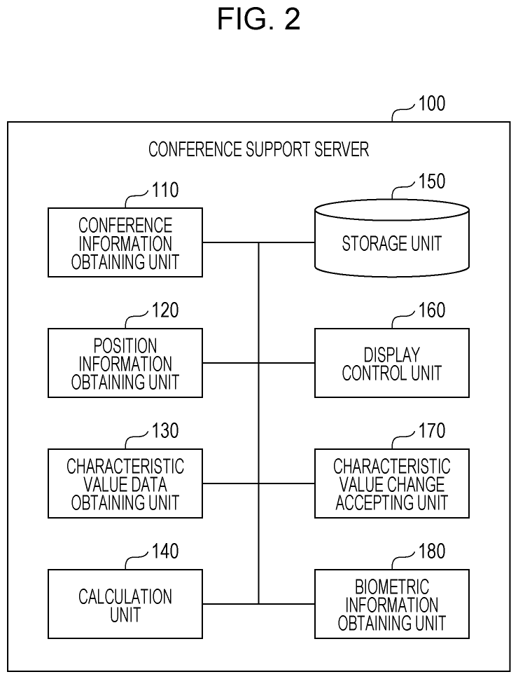

FIG. 2 illustrates a functional configuration of the conference support server 100. The conference support server 100 includes a conference information obtaining unit 110, a positioning information obtaining unit 120, and a characteristic value data obtaining unit 130. The conference support server 100 further includes a calculation unit 140, a storage unit 150, and a display control unit 160. The conference support server 100 further includes a characteristic value change accepting unit 170 and a biometric information obtaining unit 180.

The conference information obtaining unit 110 obtains information on a conference to be supported by the conference support server 100. The obtained information on the conference includes meeting information and statement/materials-related information. The obtained information is saved and stored in a storage device in the conference support server 100 or in a storage means that can be accessed from the conference support server 100, such as a storage server.

The meeting information is information for designing a conference (or a meeting) to be supported. Specifically, the meeting information includes the name of the conference, the date and time at which the conference is held, the place at which the conference is held, the purpose of the conference, and participant names. The meeting information is input manually by using an input device such as a keyboard when, for example, the conference is held or scheduled. If a management system that manages information on the conference is available, meeting information of the conference to be supported may be obtained from the management system.

The statement/materials-related information includes the details of a statement and materials related to the statement (hereinafter referred to sometimes as “statement and its materials” for short) presented during the conference, and information related to the statement and its related materials. Specifically, statement/materials-related information about a statement includes, for example, the details (or content) of the statement, and context information indicating information concerning the statement that was made, such as who made the statement and when the statement was made. Statement/materials-related information about related materials includes, for example, the related materials (content) and context information indicating information concerning the related materials that were presented, such as who presented the related materials and when the related materials were presented. Statement/materials-related information may include relationship information indicating the relationship in content between the statement and the related materials.

The statement/materials-related information described above is obtained by, for example, performing audio analysis of the speech in a statement recorded using a microphone to extract text data or reading character portions in captured images of the conference or captured images of the statement's related materials to extract text data. The captured images of the conference or the statement's related materials are also obtained as statement/materials-related information of the content. The content of the related materials or the like, which is presented as electronic data, may be obtained directly as statement/materials-related information or may be separated into text data and image data, each of which may be obtained as statement/materials-related information. When extracted text data and image data are each obtained as statement/materials-related information, relationship information for associating the text data and the image data with each other may be generated and added to each of the text data and the image data. Alternatively, the relationship information may be stored as statement/materials-related information. The statement/materials-related information may be input manually by a person such as the conference facilitator or an input operator.

The positioning information obtaining unit 120 obtains information for positioning, in an argument, statements made during the conference and their related materials presented during the conference. The information for positioning a statement and its materials in an argument (hereinafter, positioning information) is information indicating into which component of an argument model the statement and its materials are categorized. The argument model may be implemented as any of various existing argument models. Examples of the argument model include the Toulmin model and a model based on dialectics. That is, statements and their materials are categorized into components of a predetermined argument model in accordance with the positioning information obtained by the positioning information obtaining unit 120. As an example, the Toulmin model is applied in the positioning information obtaining unit 120. In this case, each of statements made during the conference or its related materials presented during the conference are categorized into any one of the components of the Toulmin model, namely, “grounds”, “claim”, “warrants”, “rebuttals”, or “backing”. The positioning information based on the argument model is used to identify the relationship between the statements and their materials, that is, each of the statements and its materials are associated with another of the statements and its materials. The positioning information obtaining unit 120 is an example of a positioning information obtainer, an example of a categorizer, and an example of an associator.

The positioning information is input (i.e., statements and their related materials are categorized) manually by a person such as the conference facilitator or an input operator by using an input device such as a keyboard, for example. Alternatively, statements and their materials may be analyzed and mechanically categorized in accordance with the results of analysis. As an example categorization technique, specific words or phrases relating to categories may be set in advance. As a result of analysis of a statement made during the conference or its related materials presented during the conference, if any of the set specific words or phrases is detected, the statement or its materials are categorized as a category corresponding to the detected word or phrase. In a specific example, if a certain statement includes a phrase such as “the grounds of . . . are . . . ” or “the data based on this is . . . ”, the statement may be categorized as “grounds”. In another example technique for categorizing statements and their materials, statement rules corresponding to categories may be determined in advance. Each of statements made during the conference is categorized in accordance with the statement rule met by the statement. In a specific example, a rule specifying that a category name should be placed at the beginning of a statement may be set. The phrase at the beginning of each statement may be extracted, and the statement may be categorized in accordance with the extracted phrase. In still another example technique for categorizing statements and their materials, a determination means that uses a machine learning algorithm may be provided. Categorization performed by the conference facilitator or an input operator may be learned to generate teacher data, and the determination means may categorize statements and their materials from the teacher data.

The characteristic value data obtaining unit 130 obtains characteristic values of a statement and its materials whose position in the argument has been identified (or categorized) by the positioning information obtaining unit 120. The characteristic values are values indicating the characteristics of a statement and its materials, the statement being made in connection with a “claim” in the argument. The characteristics of a statement and its materials include the level of importance of the statement and its materials for the “claim”, and the degree to which conference participants agree (hereinafter referred to as “degree of agreement” on the “claim”). The level of importance is information indicating whether the statement and its materials are important as a category based on the argument model. For example, the Toulmin model is used as an example. When a statement and its materials are categorized as “warrants”, the level of importance indicates the degree to which the content of the statement and its materials is important as a “warrant” for the “claim”. When a statement and its materials are categorized as “rebuttals”, the level of importance indicates how probable it is that the content of the statement and its materials will be a “rebuttal” for the “claim”. The degree of agreement among the conference participants is information indicating the ratio of agreements to disagreements on a statement and its materials among the conference participants. The characteristic values are input manually by a person such as the conference facilitator or an input operator by using an input device such as a keyboard, for example. The characteristic value data obtaining unit 130 is an example of a level-of-importance obtainer, an example of a degree-of-agreement obtainer, and an example of a characteristic value obtainer.

The calculation unit 140 calculates claim characteristic values indicating the characteristics of a “claim” in an argument from the characteristic values of statements in the argument and from the result of association between the statements. The claim characteristic values are values indicating the degree to which the conference participants are convinced of the “claim” in the argument. The claim characteristic values include a degree of claim agreement and a degree of claim certainty. The degree of claim agreement refers to the degree to which the conference participants agree on the claim in the argument. The degree of claim certainty refers to the degree to which the claim in the argument is certain. The Toulmin model is used by way of example. The calculation unit 140 calculates claim characteristic values by using, for example, the level of importance and the degree of agreement on each of statements and their materials categorized as “grounds”, “warrants”, and “rebuttals” of the Toulmin model, the level of importance and the degree of agreement being obtained by the characteristic value data obtaining unit 130. A specific example of the calculation will be described below. The calculation unit 140 is an example of a calculator.

The storage unit 150 stores various types of information and processing results, which are used for processing performed by the conference support server 100. Specifically, the storage unit 150 stores the information on the conference to be supported, such as the meeting information and the statement/materials-related information, which are obtained by the conference information obtaining unit 110, the positioning information of statements and their materials, which are obtained by the positioning information obtaining unit 120, and the characteristic values of the statements and their materials, such as the levels of importance and the degrees of agreement, which are obtained by the characteristic value data obtaining unit 130. The storage unit 150 further stores the claim characteristic values, such as the degree of claim agreement and the degree of claim certainty, which is obtained as a result of the calculation performed by the calculation unit 140. Further, the storage unit 150 stores information on the argument model used by the positioning information obtaining unit 120, such as information on the components of the argument model and the relationship between the components, and stores display templates used to provide display based on the argument model, which will be described below.

The display control unit 160 displays, on a display device (or a display), results of the calculation performed by the calculation unit 140 and various types of data stored in the storage unit 150. Examples of the display device include a display unit 320 of the administrator terminal 300 described below. The details of items displayed on the display device by the display control unit 160 will be described below. The display control unit 160 or a combination of the display control unit 160 and the display device is an example of a display and is an example of an output unit.

The characteristic value change accepting unit 170 changes a characteristic value (at least one of the level of importance and the degree of agreement) obtained by the characteristic value data obtaining unit 130 in response to receipt of a user input. The characteristic value change accepting unit 170 is an example of a change unit. When the characteristic value change accepting unit 170 accepts a change of a characteristic value, the calculation unit 140 recalculates the claim characteristic values accordingly.

The biometric information obtaining unit 180 obtains biometric information of the conference participants. The biometric information obtained by the biometric information obtaining unit 180 is referred to by the positioning information obtaining unit 120 to categorize statements and their materials. Examples of the biometric information include pulse, blood pressure, breathing, and electric properties of skin. The biometric information may be used such that, for example, when it is determined that a person who made a statement is very nervous from biometric information, the biometric information is used as reference information indicating that the statement probably indicates disagreement such as a rebuttal. The biometric information obtaining unit 180 may be implemented as various sensors corresponding to biometric information to be obtained. The biometric information obtaining unit 180 is an example of a biometric information obtainer. The biometric information obtaining unit 180 is optional. A person such as the conference facilitator or an input operator may manually input positioning information or the like by referring to the information obtained by the biometric information obtaining unit 180.

The conference support server 100 includes a processing device that performs data processing and device control. The processing device is implemented by a central processing unit (CPU), a read only memory (ROM), and a random access memory (RAM) serving as a work memory. The ROM stores a program for controlling the operation of the conference support server 100. The CPU reads a program from the ROM and executes the program to perform various types of operation control or various processing operations. The conference information obtaining unit 110, the positioning information obtaining unit 120, and the characteristic value data obtaining unit 130 are implemented by a network interface for receiving various types of data or an input device for accepting user input and by the processing device described above, for example. The calculation unit 140 and the display control unit 160 are implemented by the processing device described above, for example. The storage unit 150 is implemented by, for example, a storage device included in the conference support server 100, such as a magnetic disk device or a non-volatile memory. The characteristic value change accepting unit 170 is implemented by an input device for accepting user input and by the processing device described above, for example. The biometric information obtaining unit 180 is implemented by an interface connectable to a sensor that collects data to be used as biometric information and by the processing device described above, for example.

### Functional Configuration of Participant Terminal

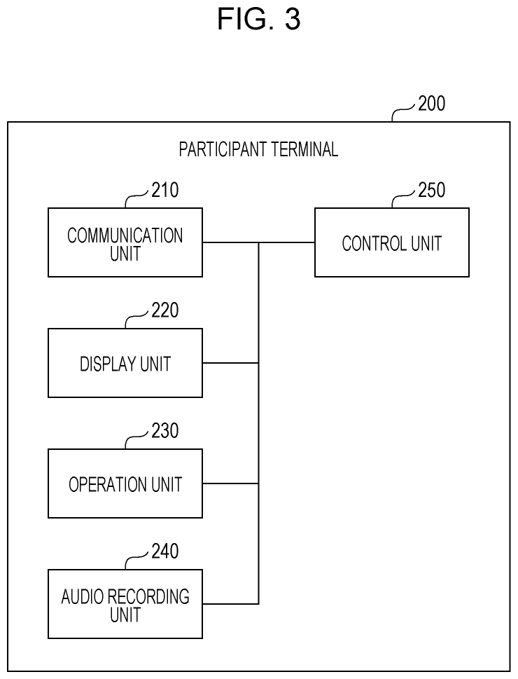

FIG. 3 illustrates a functional configuration of each of the participant terminals 200. The participant terminal 200 includes a communication unit 210, a display unit 220, an operation unit 230, an audio recording unit 240, and a control unit 250. Each of the participant terminals 200 is implemented by, for example, an information processing device such as a personal computer (PC).

The communication unit 210 is an interface for exchanging data with the conference support server 100. For example, the communication unit 210 is implemented as a network interface for connecting to a network to which the conference support server 100 is connected. The display unit 220 is a device that displays related materials or the like presented during the conference. For example, the display unit 220 is implemented as a display device such as a liquid crystal display. The operation unit 230 is a device used by a conference participant to perform operations such as presenting related materials or inputting information on a statement and its materials. For example, the operation unit 230 is implemented as an input device such as a keyboard or a mouse. The audio recording unit 240 is a device that records speech in a statement made by the conference participant. For example, the audio recording unit 240 is implemented as a microphone. The control unit 250 is a device that controls the participant terminal 200. For example, the control unit 250 is implemented by a CPU, a ROM that stores a program to be executed by the CPU, a RAM serving as a work memory, and so on.

Each conference participant makes a statement or presents related materials during the conference by using the operation unit 230 and the audio recording unit 240 of the participant terminal 200. The statement and the related material are transmitted from the participant terminal 200 to the conference support server 100 via the communication unit 210 and a network and are processed. The presented related materials are delivered from the conference support server 100 to the participant terminals 200 of the other conference participants, if necessary, and are displayed on the display units 220. This allows each conference participant to view related materials presented by any other conference participant, which are displayed on the display unit 220.

### Functional Configuration of Administrator Terminal

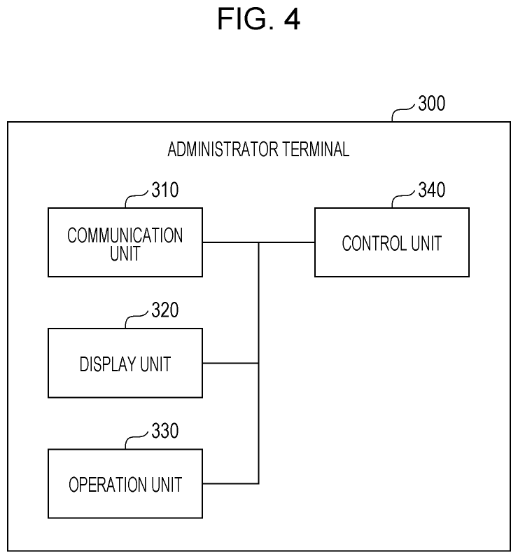

FIG. 4 illustrates a functional configuration of the administrator terminal 300. The administrator terminal 300 includes a communication unit 310, a display unit 320, an operation unit 330, and a control unit 340. The administrator terminal 300 is implemented by, for example, an information processing device such as a personal computer (PC). The user of the administrator terminal 300 is a person who inputs information to the conference support server 100. The user of the administrator terminal 300 is hereinafter referred to as an administrator. Typically, the administrator is a person who is given a particular role, such as the conference facilitator or an input operator, and is not a conference participant. However, depending on the type of conference, the administrator may participate in the conference in a manner similar to other conference participants. When the administrator is also a conference participant and the administrator terminal 300 is also used as a participant terminal 200, the administrator terminal 300 may include an audio recording unit for recording speech in a statement made by the administrator who is a conference participant.

The communication unit 310 is an interface for exchanging data with the conference support server 100. For example, the communication unit 310 is implemented as a network interface for connecting to a network to which the conference support server 100 is connected. The display unit 320 is a device that displays the processing result of the conference support server 100 on the basis of the argument model. For example, the display unit 320 is implemented as a display device such as a liquid crystal display. When the administrator terminal 300 is also used as a participant terminal 200, the display unit 320 also displays related materials or the like presented during the conference. The operation unit 330 is a device used to input information on a statement and its materials of each conference participant, such as the statement/materials-related information, the positioning information, or the characteristic value. For example, the operation unit 330 is implemented as an input device such as a keyboard, a mouse, or dedicated buttons. In the operation using the keyboard or the mouse, the operator operates an operation screen displayed on the display unit 320 to input information. When the dedicated buttons are used, the dedicated buttons may be separately associated with pieces of positioning information or characteristic values. When the administrator terminal 300 is also used as a participant terminal 200, the operation unit 330 is also used by the administrator, who serves as a conference participant, to present related materials. The control unit 340 is a device that controls the administrator terminal 300. For example, the control unit 340 is implemented by a CPU, a ROM that stores a program to be executed by the CPU, a RAM serving as a work memory, and so on.

The administrator terminal 300 receives a processing result from the conference support server 100 and displays the processing result on the display unit 320. Further, the administrator terminal 300 displays related materials or the like presented from the participant terminals 200 on the display unit 320. Based on the processing result and the related materials or the like, which are displayed on the display unit 320, the validity of the claim in the argument, the administrator determines, whether the content of each statement and its materials and the position of each statement and its materials in the argument are biased, and the degree to which a specific conference participant participates in the conference (the number of statements and materials), for example. Based on this determination, the administrator may encourage the expression of opinions about insufficient components of the argument model, or ask for opinions from conference participants who have posted a few statements. When the administrator is also a conference participant and the administrator terminal 300 is also used as a participant terminal 200, the administrator, who serves as a conference participant, may operate the operation unit 330 of the administrator terminal 300 to make a statement or present related materials during the conference.

### Example of Argument Model

The conference support server 100 categorizes statements made by the conference participants or related materials presented from the conference participants during the conference on the basis of a predetermined argument model and calculates claim characteristic values of a claim in the argument. The argument model to be used to categorize statements and their materials may be implemented as any of various existing argument models, as described above. In the following, the argument model will be described in further detail using the Toulmin model, which is an example argument model, as an example.

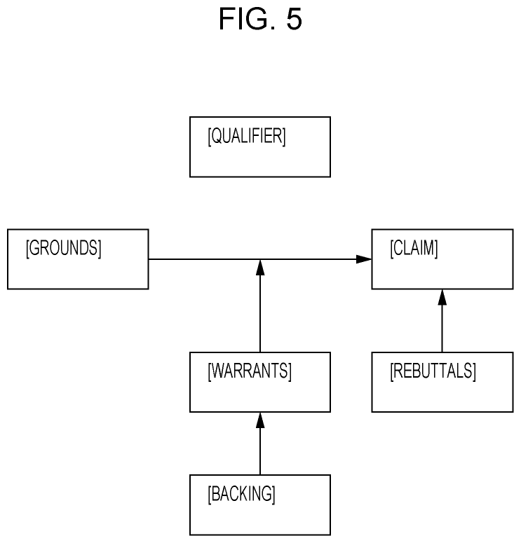

FIG. 5 illustrates the structure of the Toulmin model. As illustrated in FIG. 5, the Toulmin model has six components of argument: “grounds”, “claim”, “warrants”, “backing”, “rebuttals”, and “qualifier”. The “grounds” component refers to a fact and the like supporting a claim. The “claim” component refers to a conclusion and the like arrived at from the grounds. The “warrants” component refers to reasons and the like why the grounds support the claim. The “backing” component refers to evidence and the like provided to support the warrants. The “rebuttals” component refers to counter arguments which may refute the claim. The “qualifier” component refers to the strength of the claim or the qualitative correctness of the claim.

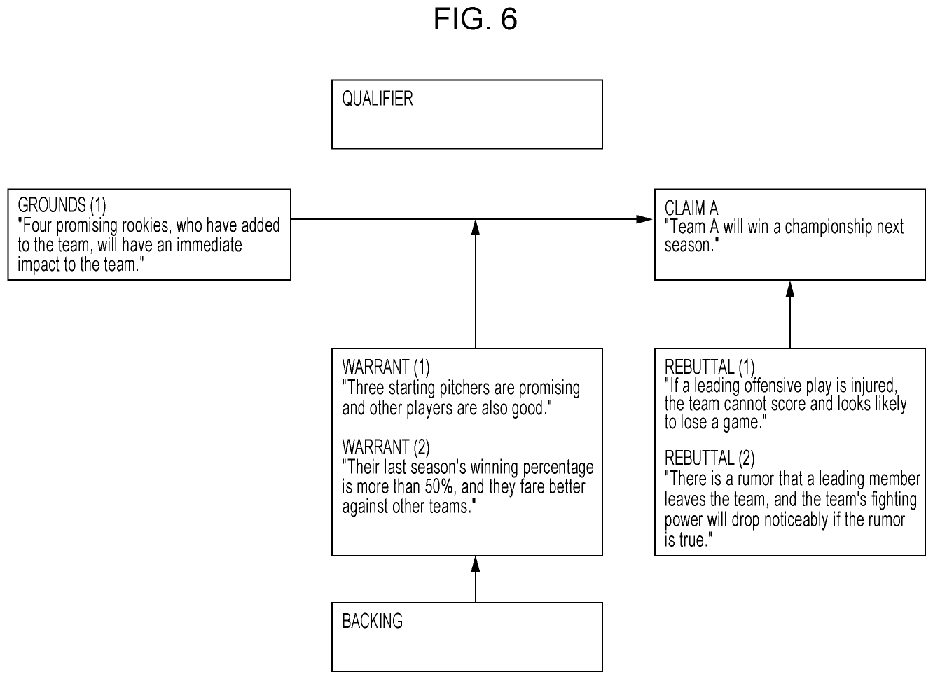

FIG. 6 illustrates an example of analysis of an argument for and against a certain “claim” using the Toulmin model. The illustrated example provides an argument for and against “claim A” that “team A will win a championship next season”. As “grounds (1)” for the “claim A”, the statement has been made: “Four promising rookies, who have added to the team, will have an immediate impact to the team”. Further, as “warrant (1)” for the “grounds (1)”, the statement has been made: “Three starting pitchers are promising and other players are also good”. Also, as “warrant (2)”, the statement has been made: “Their last season's winning percentage is more than 50%, and they fare better against other teams”. Further, as “rebuttal (1)” against the “claim A”, the statement has been made: “If a leading offensive play is injured, the team cannot score and looks likely to lose a game”. Also, as “rebuttal (2)”, the statement has been made: “There is a rumor that a leading member leaves the team, and the team's fighting power will drop noticeably if the rumor is true”.

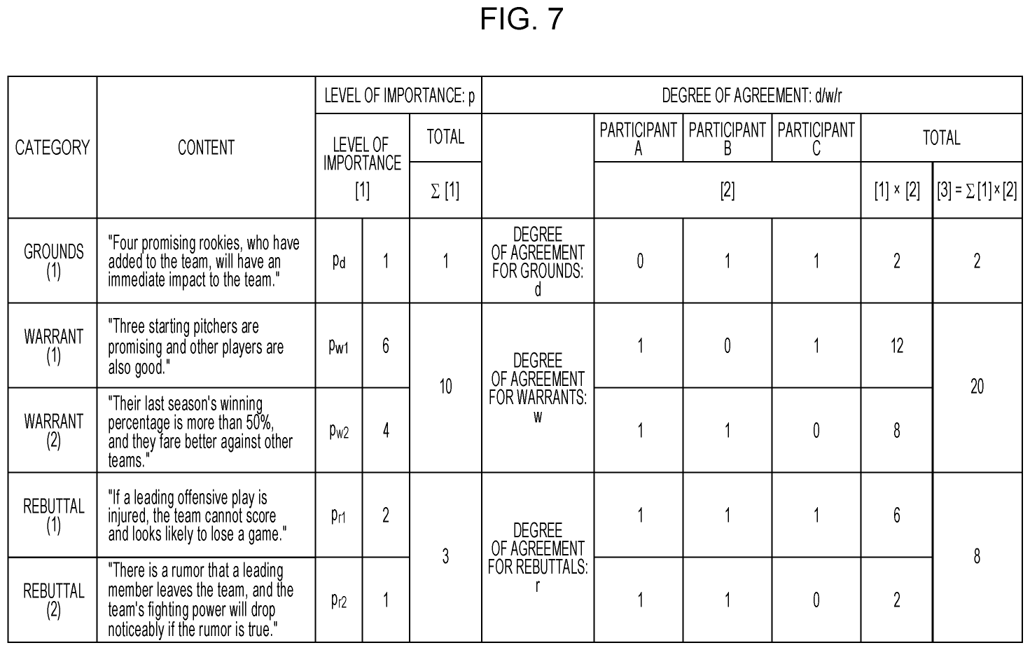

FIG. 7 illustrates an example of characteristic values (levels of importance and degrees of agreement) set for statements in the argument illustrated in FIG. 6. In the example illustrated in FIG. 7, the level of importance is represented by a relative value, with a larger value indicating higher importance. The degree of agreement is set to either “0” (disagreement) or “1” (agreement).

The levels of importance of the respective statements are input, and the total level of importance is calculated for each of the components of the Toulmin model. Specifically, for “warrants”, a level of importance of “6” for the “warrant (1)” and a level of importance of “4” for the “warrant (2)” are added together to calculate a level of importance of “10” for warrants. Likewise, for “rebuttals”, a level of importance of “2” for the “rebuttal (1)” and a level of importance of “1” for the “rebuttal (2)” are added together to calculate a level of importance of “3” for rebuttals.

The degrees of agreement of three conference participants (participant A, participant B, and participant C) are input for each of the statements of the “grounds (1)”, the “warrant (1)”, the “warrant (2)”, the “rebuttal (1)”, and the “rebuttal (2)”. The total degree of agreement for each statement is multiplied by the corresponding level of importance. The sum of multiplication values is calculated for each of the components of the Toulmin model. Specifically, for “grounds”, a level of importance of “1” and the sum of the degrees of agreement, namely, “2” are multiplied to find a multiplication value of “2”. Thus, the total, or “2”, is determined. For “warrant (1)”, a level of importance of “6” and the sum of the degrees of agreement, namely, “2”, are multiplied to find a multiplication value of “12”. For “warrant (2)”, a level of importance of “4” and the sum of the degrees of agreement, namely, “2”, are multiplied to find a multiplication value of “8”. For “warrants”, accordingly, the sum of the multiplication values, namely, “20”, is determined. Similar calculation is performed for “rebuttals”. Specifically, for “rebuttal (1)”, a level of importance of “2” and the sum of the degrees of agreement, namely, “3”, are multiplied to find a multiplication value of “6”. For “rebuttal (2)”, a level of importance of “1” and the sum of the degrees of agreement, namely, “2”, are multiplied to find a multiplication value of “2”. For “rebuttals”, accordingly, the sum of the multiplication values, namely, “8”, is determined.

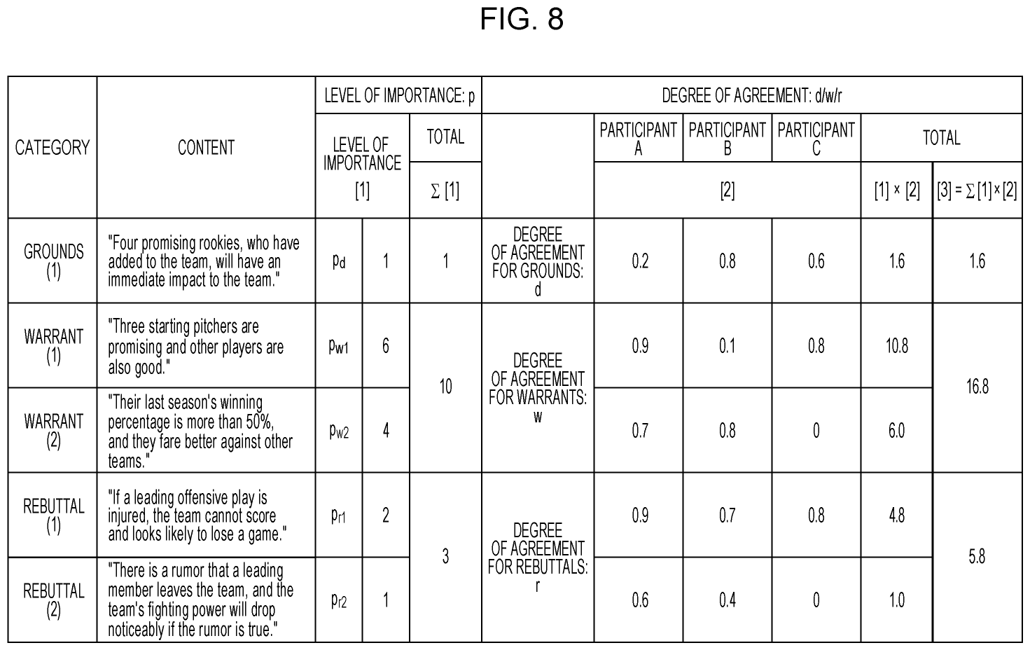

FIG. 8 illustrates another example of the characteristic values (levels of importance and degrees of agreement) set for statements in the argument illustrated in FIG. 6. In the example illustrated in FIG. 8, the respective levels of importance are set in a way similar to that in the example illustrated in FIG. 7. The degrees of agreement are each set to any of 11 values in the range from “0” to “1” in increments of 0.1 in accordance with the degree to which each conference participant agrees on a statement and its materials.

The calculation of the degree of agreement will be described with reference to FIG. 8. For “grounds”, a level of importance of “1” and the sum of the degrees of agreement, namely, “1.6”, are multiplied to find a multiplication value of “1.6”. Thus, the total, or “1.6”, is determined. For “warrant (1)”, a level of importance of “6” and the sum of the degrees of agreement, namely, “1.8”, are multiplied to find a multiplication value of “10.8”. For “warrant (2)”, a level of importance of “4” and the sum of the degrees of agreement, namely, “1.5”, are multiplied to find a multiplication value of “6.0”. For “warrants”, accordingly, the sum of the multiplication values, namely, “16.8”, is determined. Similar calculation is performed for “rebuttals”. Specifically, for “rebuttal (1)”, a level of importance of “2” and the sum of the degrees of agreement, namely, “2.4”, are multiplied to find a multiplication value of “4.8”. For “rebuttal (2)”, a level of importance of “1” and the sum of the degrees of agreement, namely, “1.0”, are multiplied to find a multiplication value of “1.0”. For “rebuttals”, accordingly, the sum of the multiplication values, namely, “5.8”, is determined.

Example of Calculation of Claim Characteristic Values

The calculation of the claim characteristic values by the calculation unit 140 will be described in further detail. The calculation unit 140 calculates, based on characteristic values set for statements and their materials in an argument, the claim characteristic values (the degree of claim agreement and the degree of claim certainty) of a claim in the argument. The calculation unit 140 normalizes the claim characteristic values, which are obtained as a result of the calculation, so that the claim characteristic values fall within a specified range (such as the range from 0 to 1, the range from −1 to +1, or the range from 0 to 100%). When the Toulmin model is used as an argument model, claim characteristic values are calculated by using the level of importance and the degree of agreement that are set for each of statements and its materials categorized as “grounds”, “warrants”, and “rebuttals”. In the claim characteristic values, the degree of claim agreement is calculated using, for example, equation (1) below. In the claim characteristic values, the degree of claim certainty is calculated using, for example, equation (2) below.

$$c = \frac{{\sum }_{h = 0}^{m} {d}_{h} {p}_{d} + {\sum }_{k = 0}^{m} {\sum }_{i = 0}^{n} ( {w}_{ik} {p}_{wi} ) + {\sum }_{k = 0}^{m} {\sum }_{j = 0}^{l} ( {r}_{jk} {p}_{rj} )}{( m + 1 ) \times ( {p}_{d} + {\sum }_{i = 0}^{n} {p}_{wi} + {\sum }_{j = 0}^{l} {p}_{rj} )} \qquad ( 1 )$$

Equation (1) is an example of an equation for calculating a degree of claim agreement c, given that (m+1) (0 to m) conference participants participate in a conference, and statements and their materials made in connection with a certain “claim” include (n+1) (0 to n) statements and their materials, which are categorized as “warrants”, and (1+1) (0 to 1) statements and their materials, which are categorized as “rebuttals”. In equation (1), the sum of multiplication values of the levels of importance and the degrees of agreement for “grounds”, the sum of multiplication values of the levels of importance and the degrees of agreement for “warrants”, and the sum of multiplication values of the levels of importance and the degrees of agreement for “rebuttals” are totaled and the total is divided by the sum of the levels of importance for “grounds”, “warrants”, and “rebuttals”. Accordingly, the degree of claim agreement c is determined.

In equation (1), p_{d} denotes the level of importance of a statement and its materials categorized as “grounds”, and dₕ denotes the degree of agreement of the h-th (h:0≤h≤m) conference participant on this statement and its materials. Further, p_{wi} denotes the level of importance of the i-th (i:0≤i≤n) statement and its materials categorized as “warrants”, and wᵢₖ denotes the degree of agreement of the k-th (k:0≤k≤m) conference participant on this statement and its materials. Further, pᵣⱼ denotes the level of importance of the j-th (j:0≤j≤n) statement and its materials categorized as “rebuttals”, and rⱼₖ denotes the degree of agreement of the k-th conference participant on this statement and its materials.

$$b = \frac{{\sum }_{h = 0}^{m} {d}_{h} {p}_{d} + {\sum }_{k = 0}^{m} {\sum }_{i = 0}^{n} ( {w}_{ik} {p}_{wi} )}{( m + 1 ) \times max ( ( {p}_{d} + {\sum }_{i = 0}^{n} {p}_{wi} ) , ( {\sum }_{j = 0}^{l} {p}_{rj} ) )} - \frac{{\sum }_{k = 0}^{m} {\sum }_{j = 0}^{l} ( {r}_{jk} {p}_{rj} )}{( m + 1 ) \times max ( ( {p}_{d} + {\sum }_{i = 0}^{n} {p}_{wi} ) , ( {\sum }_{j = 0}^{l} {p}_{rj} ) )} \qquad ( 2 )$$

Equation (2) is an example of an equation for calculating a degree of claim certainty b on assumptions similar to those in equation (1). In equation (2), variables p_{d}, dₕ, p_{Wi}, wᵢₖ, pᵣⱼ, and rⱼₖ are similar to the variables in equation (1). In equation (2), a value obtained by dividing the sum of multiplication values of the levels of importance and the degrees of agreement for “rebuttals” by a larger one of the sum of the levels of importance for “grounds” and “warrants” and the sum of the levels of importance for “rebuttals” is subtracted from a value obtained by dividing the total of the sum of multiplication values of the levels of importance and the degrees of agreement for “grounds” and the sum of multiplication values of the levels of importance and the degrees of agreement for “warrants” by a larger one of the sum of the levels of importance for “grounds” and “warrants” and the sum of the levels of importance for “rebuttals”. Accordingly, the degree of claim certainty b is determined.

In equation (2), the denominator of each term is a larger one of the sum of the levels of importance for “grounds” and “warrants” and the sum of the levels of importance for “rebuttals”. If normalization is performed by using respective levels of importance such that the denominator of the first term is the sum of the levels of importance for “grounds” and “warrants” and the denominator of the second term is the sum of the levels of importance for “rebuttals”, the levels of importance for “grounds” and “warrants” and the levels of importance for “rebuttals” are separately normalized, and the levels of importance in the two terms are not related to each other, which is not desirable. Setting the denominators as in equation (2) allows a minimum value or a maximum value, namely, −1.0 or +1.0, to be taken for a higher level of importance. Unlike the degree of claim agreement c (equation (1)) given by an expression whose denominator is the sum of the levels of importance for “grounds”, “warrants”, and “rebuttals”, degrees of claim agreement are plotted on a graph in such a manner that the distribution of the degrees of claim certainty is enlarged on the high-level-of-importance side.

For the statements of the “grounds (1)”, the “warrant (1)”, the “warrant (2)”, the “rebuttal (1)”, and the “rebuttal (2)” for and against the “claim A” illustrated in FIG. 6, the respective levels of importance and degrees of agreement illustrated in FIG. 7 are obtained. Based on the obtained levels of importance and degrees of agreement, the degree of claim agreement and the degree of claim certainty are calculated using equations (1) and (2). The degree of claim agreement is 0.71, and the degree of claim certainty is +0.42. Since the degree of claim certainty is equal to +0.42 in the range (range of variations) from −1.0 to +1.0, the result of the argument may be construed as somewhat positive for the “claim A”. The scales of the degree of claim certainty are defined as follows.

−1.0: Uncertain

0: Neutral

+1.0: Certain

Since the degree of claim agreement is 0.71 in the range (range of variations) from 0 to 1.0, the result of the argument may indicate that the conference participants partly disagree but totally agree on the “claim A”. The scales of the degree of claim agreement are defined as follows.

1: Agree

0: Disagree

Also, for the statements of the “grounds (1)”, “warrant (1)”, the “warrant (2)”, the “rebuttal (1)”, and the “rebuttal (2)” for and against the “claim A” illustrated in FIG. 6, the respective levels of importance and degrees of agreement illustrated in FIG. 8 are obtained. In this case, the degree of claim agreement is 0.58, and the degree of claim certainty is 0.38. Accordingly, the result of the argument may be construed as somewhat positive for the “claim A” and may indicate that agreement is slightly stronger than disagreement.

### Display and Output of Processing Result

The processing result of the conference support server 100 is displayed on a display device (e.g., the display unit 320 of the administrator terminal 300) by the display control unit 160. Any content may be displayed so long as the administrator may be informed of at least a processing result, that is, the claim characteristic values (such as the degree of claim agreement and the degree of claim certainty) of each “claim”. As an example, items may be displayed according to the layout based on the Toulmin model illustrated in FIG. 5 and FIG. 6, and the calculated claim characteristic values may be added to the displayed items. To display items according to the layout based on the Toulmin model, for example, the display control unit 160 reads a display template for the layout, which is stored in the storage unit 150 in advance, from the storage unit 150 and fills the template with the statements and their materials and the claim characteristic values to generate a display screen.

In addition to the claim characteristic values, characteristic values (such as the levels of importance and the degrees of certainty) of the individual statements and their materials of the “grounds”, the “warrants”, and the “rebuttals” for and against the “claim” may be added to the display screen before the display screen is displayed. In this case, the display control unit 160 reads the respective characteristic values of the statements and their materials, which are obtained by the characteristic value data obtaining unit 130 and stored in the storage unit 150, and adds the read characteristic values to the corresponding statements and their materials on the display screen.

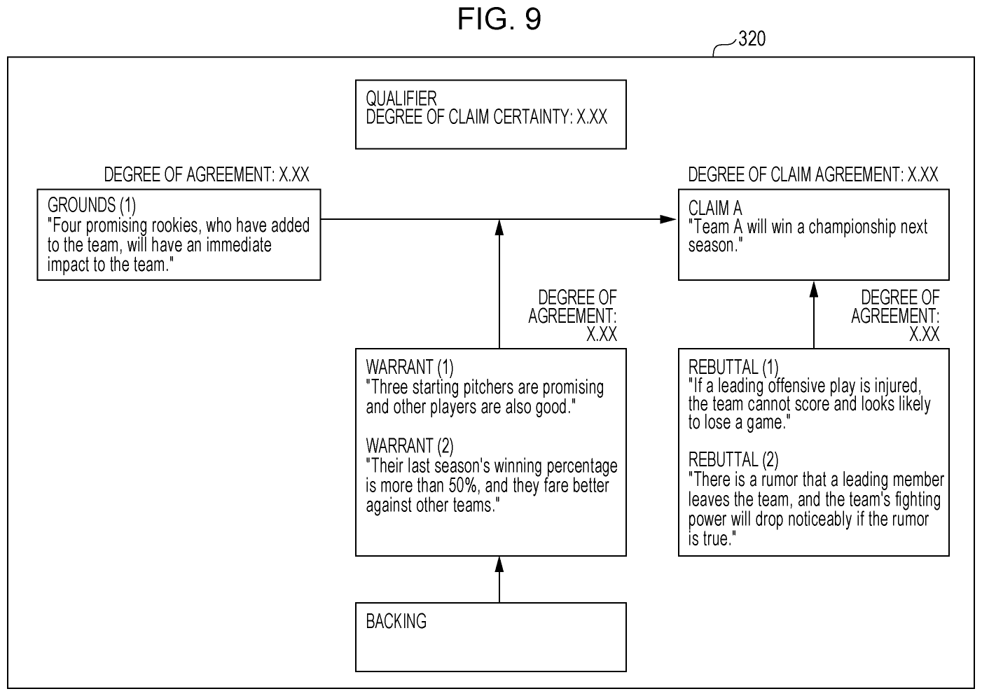

FIG. 9 illustrates an example of displayed processing results of the conference support server 100. In the illustrated example, the processing results of the conference support server 100 indicate that a display screen generated by the display control unit 160 in accordance with the layout based on the argument model (in the illustrated example, the Toulmin model) is displayed on the display unit 320 of the administrator terminal 300. In the example illustrated in FIG. 9, among the components of the argument model, the “claim” is displayed together with the degree of claim agreement such that the degree of claim agreement appears above the “claim” box, and the “qualifier” is displayed together with the degree of claim certainty such that the degree of claim certainty appears in the “qualifier” category box. Further, the “grounds”, the “warrants”, and the “rebuttals” are displayed together with the respective degrees of agreement such that the degrees of agreement appear above the upper right corners of the “grounds”, the “warrants”, and the “rebuttals” category boxes.

The display screen illustrated in FIG. 9 is for illustrative purposes only. In the example illustrated in FIG. 9, the “grounds”, the “warrants”, and the “rebuttals” are displayed together with the respective degrees of agreement. Alternatively, the statements and their materials categorized as each category may be each displayed together with its degree of agreement. Alternatively, both the degree of agreement and the level of importance may be displayed for each category or for each statement and its materials. The degree of agreement or level of importance for each category may be expressed by the sum or average of the characteristic values of the statements and their materials in the corresponding category. The display of items may be switched in accordance with the operation of the administrator. Each value range may be determined as desired, but is desirably normalized among the conference participants. The information described above is displayed in real time in accordance with the progress of the conference (i.e., each time a statement and its materials are presented), which allows observation of changes in characteristic value for each category or changes in claim characteristic value due to the presentation of a new statement and its materials. Accordingly, the administrator is able to grasp the progress of the argument in accordance with the addition of statements and their materials. In response to the addition of a statement and its materials, the characteristic values or the claim characteristic values may dynamic change, which will be described in detail below.

In the example illustrated in FIG. 9, a statement and its materials are displayed in association with each category. Alternatively, each category for the argument displayed on the display screen may be selected through an operation such as a mouse click to display a statement and its materials categorized as the selected category. Alternatively, each individual statement and its materials displayed may be selected through an operation such as a mouse click to read the name of the presenter of the statement and its materials or the time of presentation of the selected statement and its materials from the storage unit 150 and to display the name of the presenter or the time of presentation.

If the claim characteristic values satisfy a predetermined display condition, the display control unit 160 of the conference support server 100 may perform control to display the claim characteristic values on the display screen. Examples of the display condition include the condition in which the degree of claim certainty has a value within a predetermined specific range, and the condition in which the degree of claim agreement is a biased value, for example, the degree of claim agreement is greater than a predetermined specific threshold value or is less than the specific threshold value. A characteristic value for each of the categories indicating the components of the argument model or a characteristic value for each statement and its materials in each category may also be displayed on the display screen when the characteristic value satisfies a predetermined display condition. Alternatively, when the claim characteristic values of a “claim” in the argument satisfy a predetermined display condition, the display control unit 160 may generate a display screen for displaying the “claim” and the other categories and also displaying statements and their materials categorized as the individual categories and may control the display device to display the display screen.

As illustrated in FIG. 9, instead of (or in addition to) the addition of the claim characteristic values or characteristic values to the display screen generated using the layout based on the argument model, the categories indicating the components of the argument model may be displayed in different styles in accordance with the claim characteristic values or the characteristic values. This allows the administrator to intuitively recognize the claim characteristic values or the characteristic values without specifically reading the claim characteristic values or the characteristic values displayed on the display screen.

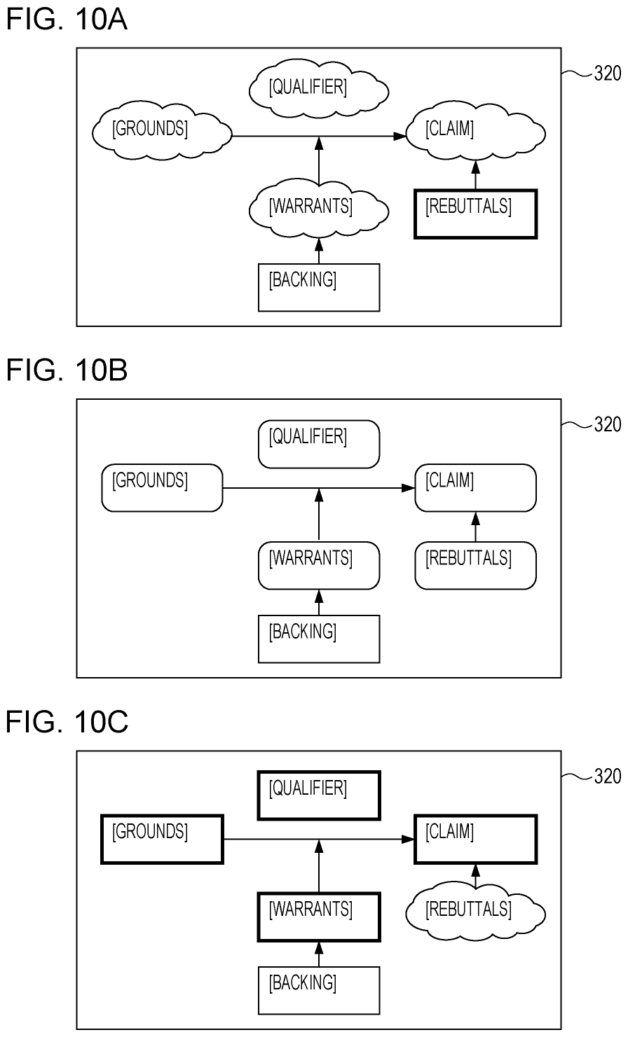

FIGS. 10A to 10C illustrate example screens that display the processing results of the conference support server 100 such that categories are displayed in different display styles in accordance with claim characteristic values and characteristic values. FIG. 10A illustrates an example display screen when the claim characteristic values are less than a first threshold value, FIG. 10B illustrates an example display screen when the claim characteristic values are greater than or equal to the first threshold value and less than a second threshold value, and FIG. 10C illustrates an example display screen when the claim characteristic values are greater than or equal to the second threshold value.

In the example illustrated in FIGS. 10A to 10C, for a claim characteristic value or a characteristic value less than the first threshold value, the box of the category indicating the corresponding component of the argument model is a box with a cloud shape (hereinafter, cloud-shaped box). For a claim characteristic value or a characteristic value greater than or equal to the first threshold value and less than the second threshold value, the box of the category of the corresponding category has a rectangular shape with rounded corners. For a claim characteristic value or a characteristic value greater than or equal to the second threshold value, the box of the corresponding category has a bold rectangular shape. In the illustrated example, among the claim characteristic values and the characteristic values, the degree of claim agreement and the degree of agreement are used to specify the display styles of the categories.

In the example illustrated in FIG. 10A, the “rebuttals” box has a bold rectangular shape since the degree of agreement for the “rebuttals” is high. The “grounds” and “warrants” boxes are cloud-shaped boxes since the degrees of agreement are low. The degree of claim agreement and the degree of claim certainty are also low accordingly. Thus, the “claim” and “qualifier” boxes are cloud-shaped boxes.

In the example illustrated in FIG. 10B, the degree of agreement for the “rebuttals” is lower than that in the example illustrated in FIG. 10A, and the “rebuttals” box has a rectangular shape with rounded corners. The degrees of agreement for the “grounds” and the “warrants” are higher than those in the example illustrated in FIG. 10A, and each of the “grounds” and “warrants” boxes has a rectangular shape with rounded corners. The degree of claim agreement and the degree of claim certainty are also higher than those in the example illustrated in FIG. 10A accordingly. Thus, each of the “claim” and “qualifier” boxes has a rectangular shape with rounded corners.

In the example illustrated in FIG. 10C, the degree of agreement for the “rebuttals” is further lower than that in the example illustrated in FIG. 10B, and the “rebuttals” box is a cloud-shaped box. The degrees of agreement for the “grounds” and the “warrants” are further higher than those in the example illustrated in FIG. 10B, and each of the “grounds” and “warrants” boxes has a bold rectangular shape. The degree of claim agreement and the degree of claim certainty are also higher than those in the example illustrated in FIG. 10B accordingly. Thus, each of the “claim” and “qualifier” boxes has a bold rectangular shape.

The display screens illustrated in FIGS. 10A to 10C are merely examples for displaying the categories of the argument model in different display styles in accordance with claim characteristic values or characteristic values. Instead of changing the type of the box of each category as in the example illustrated in FIGS. 10A to 10C, any of various other methods may be used which make the range of claim characteristic values or characteristic values visually recognizable. For example, the categories may be displayed in different colors in accordance with claim characteristic values or characteristic values. In the example illustrated in FIGS. 10A to 10C, two threshold values are set as conditions for switching the display styles. However, the number of threshold values used is not limited to that in the example described above. For example, a single threshold value may be used to display the categories in two display styles, or three or more threshold values may be used to perform finer control of display styles.

### Display of Hierarchies of Arguments

An argument may be conducted so as to be structured hierarchically. For instance, in the analysis of an argument using the Toulmin model, a statement and its materials of the “warrants” or the “rebuttals” for or against a certain “claim” may be discussed in further depth. In this case, the content of the statement and its materials of the “warrants” or the “rebuttals” of interest may be set as a new “claim” which may further be argued on the basis of another Toulmin model instance.

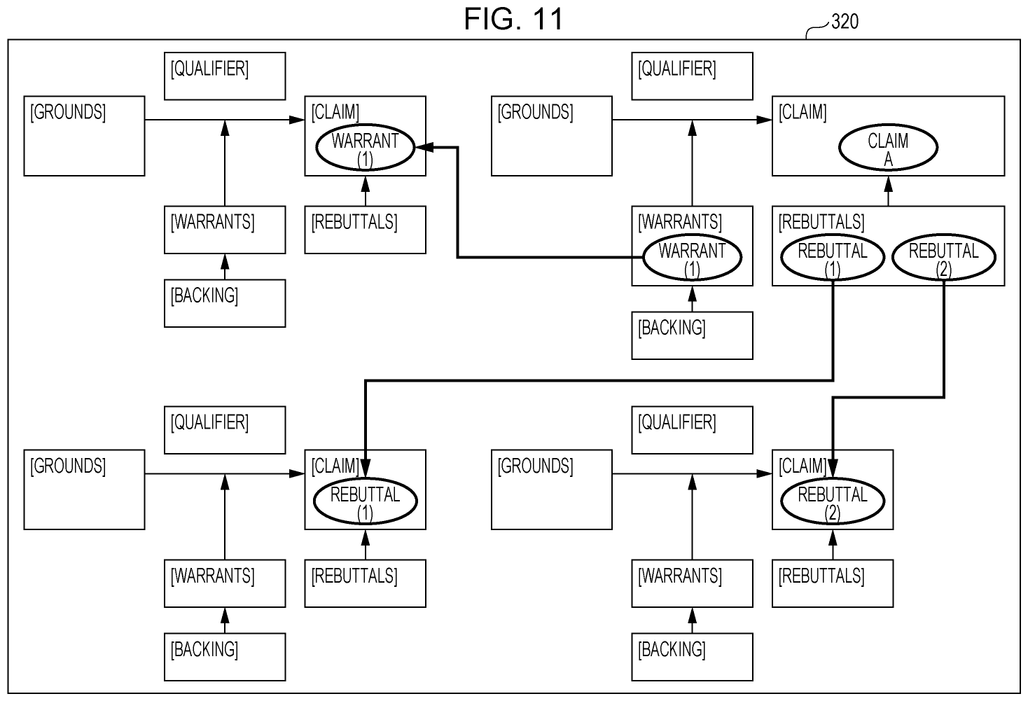

FIG. 11 illustrates an example display screen that presents hierarchies of arguments. In the example illustrated in FIG. 11, among statements and their materials presented during arguments made in connection with the “claim A”, the statements and their materials of the “warrant (1)”, the “rebuttal (1)”, and the “rebuttal (2)” are set as “claims”. In the example illustrated in FIG. 11, the correspondence between each of the subordinate arguments (the arguments made in connection with the “warrant (1)”, the “rebuttal (1)”, and the “rebuttal (2)”) and the corresponding category of the top-level argument (the argument made in connection with the “claim A”) is indicated by an arrow pointing from each category of the top-level argument to the “claim” in the corresponding one of the subordinate arguments. In the example illustrated in FIG. 11, the arguments are displayed in substantially the same size. Alternatively, selection of one of the arguments to be focused may be accepted, and the selected argument may be displayed in a larger size than the other arguments. The other arguments may be displayed in thumbnail size. For instance, when the administrator selects one of the arguments displayed in a smaller size on the display screen, the display of the arguments may be switched such that the currently selected argument is displayed in a larger size and the previously selected argument, which has been displayed in a larger size, is displayed in a smaller size.

In the example illustrated in FIG. 11, two-level hierarchies of arguments are presented. However, three- or more-level hierarchies of arguments may be displayed by further discussing the content of a statement and its materials in the subordinate arguments. As the number of levels of hierarchy increases, the number of arguments in each level also increases, resulting in all the arguments being difficult to display within a single display screen. Accordingly, only one argument to be focused may be displayed, with a sign displayed which indicates the presence of the subordinate or higher level argument(s). For instance, when a certain argument has a subordinate argument in connection with a statement and its materials of the “warrants” or “rebuttals” in the certain argument, the statement and its materials, which are broken down into the subordinate argument, may be displayed in a different display style from that of any other statement and its materials. For example, when the administrator selects, on the display screen, the statement and its materials displayed in a display style indicating that the statement and its materials are broken down into the subordinate argument, an argument having the selected statement and its materials as a claim may be displayed.

### Argument-based Change in Claim Characteristic Value

It is assumed that a statement and its materials are presented for or against a certain “claim” and that claim characteristic values are calculated on the basis of the characteristic value of the presented statement and its materials. When a new statement and its materials are presented in the progression of the argument, the levels of importance of the previously presented statements and their materials may commonly change. To address this common situation, in response to presentation of a new statement and its materials, the conference support server 100 obtains the characteristic value of the presented statement and its materials and also obtains the characteristic values of the previously presented statements and their materials again to calculate claim characteristic values.

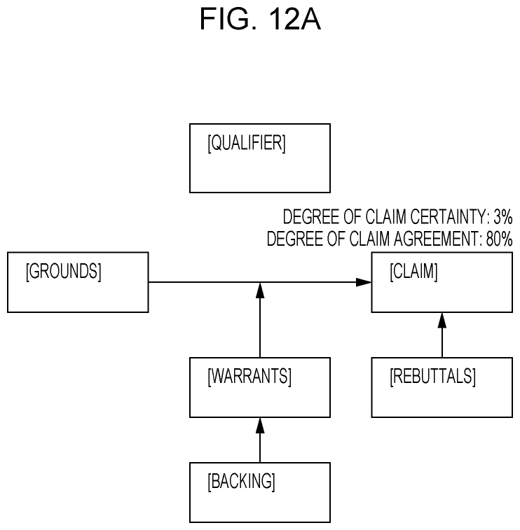

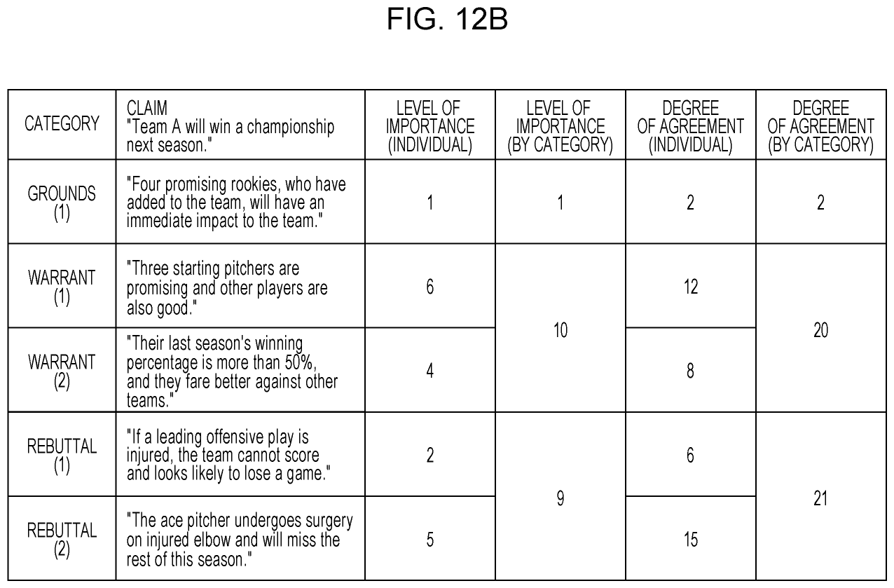

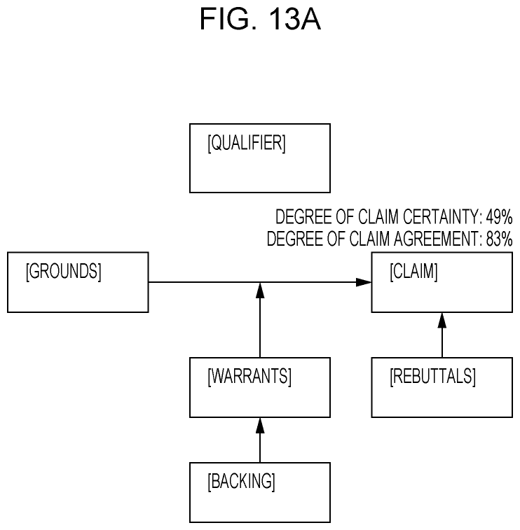

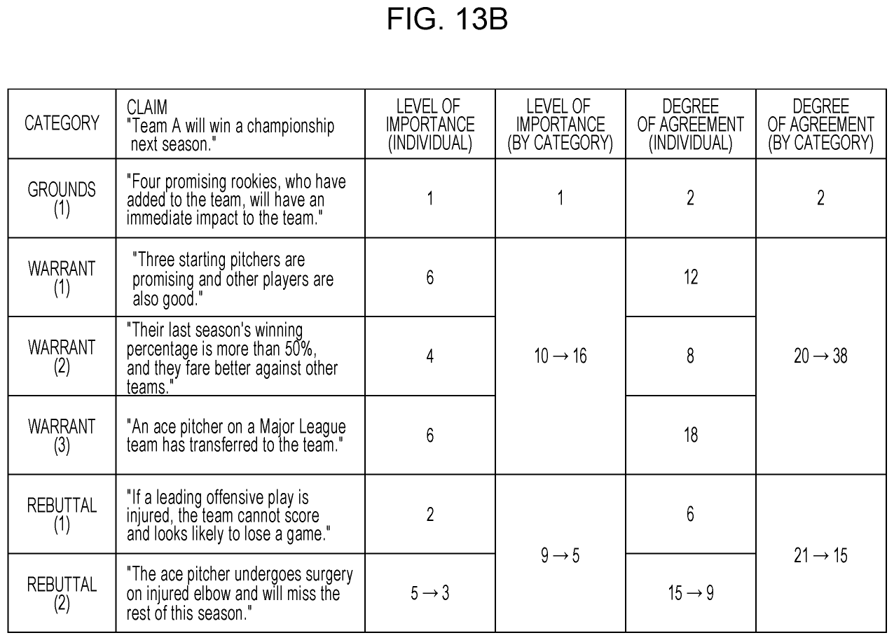

FIGS. 12A and 12B illustrate an example of characteristic values and claim characteristic values of statements and their materials made for and against a certain claim. FIGS. 13A and 13B illustrate an example change in characteristic value and claim characteristic value when a new statement and its materials are further presented in the situation illustrated in FIGS. 12A and 12B. FIG. 12A illustrates an example argument for and against a certain claim, and FIG. 12B illustrates an example of characteristic values of statements and their materials in the argument illustrated in FIG. 12A. FIG. 13A illustrates a situation in which a new statement and its materials are presented in the situation illustrated in FIG. 12A, and FIG. 13B illustrates an example of characteristic values of statements and their materials in the argument illustrated in FIG. 13A. The argument illustrated in FIGS. 12A and 12B and the argument illustrated in FIGS. 13A and 13B are based on the Toulmin model.

Referring to FIGS. 12A and 12B, the “claim” is: “Team A will win a championship next season”. The statements and their materials for the “claim” are: “Four promising rookies, who have added to the team, will have an immediate impact to the team” as the “grounds (1)”; “Three starting pitchers are promising and other players are also good” as the “warrant (1)”; and “Their last season's winning percentage is more than 50%, and they fare better against other teams” as the “warrant (2)”. The statements and their materials against the “claim” are: “If a leading offensive play is injured, the team cannot score and looks likely to lose a game” as the “rebuttal (1)”; and “The ace pitcher undergoes surgery on injured elbow and will miss the rest of this season” as the “rebuttal (2)”. The level of importance for the “rebuttal (2)” is set high. As a result, as illustrated in FIG. 12A, the processing result of the conference support server 100 indicates that the degree of claim certainty has a low value, namely, 3% (0.03), and the degree of claim agreement has a high value, namely, 80% (0.80). That is, the degree of agreement on a negative assertion against the “claim” is found to be high. Accordingly, the result may be construed as indicating that, at the current time, the participants substantially come to the conclusion of “absolutely not” for the claim “team A will win a championship next season”.

A new statement and its materials of “warrant (3)” are presented: “An ace pitcher on a Major League team has transferred to the team”. The level of importance and degree of agreement on the new statement and its materials, as illustrated in FIG. 13B, are obtained. In response to the addition of the “warrant (3)”, the level of importance and the degree of agreement for the “warrants” category are updated. In response to the addition of the “warrant (3)”, furthermore, the level of importance for the “rebuttal (2)” is determined to be reduced, with the value of the level of importance being changed from “5” to “3”. The degree of agreement for the “rebuttal (2)” is also updated. Accordingly, the level of importance and the degree of agreement for the “rebuttals” category are also updated. As a result, as illustrated in FIG. 13A, the degree of claim certainty is increased to 49% (0.49), and the degree of claim agreement is updated to 83% (0.83). The result may be construed as indicating that the participants substantially come to the conclusion that the claim that “team A will win a championship next season” is “probable depending on the situation” (“possible about 50%” on the basis of the value).

As described above, when a new statement and its materials are presented in an argument, the level of importance and the degree of agreement on the new statement and its materials are added. In addition, the levels of importance of the previously presented statements and their materials may have to be changed. The characteristic value change accepting unit 170 of the conference support server 100 accepts a change of a characteristic value, which is performed by the administrator using the administrator terminal 300. The calculation unit 140 of the conference support server 100 calculates the degree of claim agreement and the degree of claim certainty again in accordance with the added and changed characteristic values. The display control unit 160 of the conference support server 100 updates the content displayed on the display screen in accordance with the calculation results of the calculation unit 140.

When the original and updated claim characteristic values satisfy a predetermined condition, the display control unit 160 may perform control to display the updated claim characteristic value on the display screen. For example, if the degree of claim agreement or the degree of claim certainty is changed to a value greater than or equal to a threshold value set therefor in advance after update, the updated degree of claim agreement and degree of claim certainty may be displayed. Alternatively, when the original and updated claim characteristic values satisfy a predetermined condition, the display control unit 160 may generate a display screen for displaying the “claim” and the other categories and also displaying statements and their materials categorized as the individual categories and may control the display device to display the display screen. Additionally, the display control unit 160 may use any of various display methods to associate a statement and its materials whose characteristic value has been changed with the changed characteristic value on the display screen (e.g., in an associated display color) and to display the display screen.

Furthermore, when the change between the original and updated claim characteristic values satisfies a predetermined condition, the display control unit 160 may perform control to display the updated claim characteristic value on the display screen. The display of the claim characteristic values may be controlled on condition that, for example, the degree of claim certainty is changed from a value indicating a positive response to the “claim” to a value indicating a negative response to the “claim” (or from a value indicating a negative response to the “claim” to a value indicating a positive response to the “claim”) or the degree of claim agreement is changed by an amount equal to or greater than a predetermined range (range of variations). If the change between the original and updated claim characteristic values satisfies the predetermined condition, the display control unit 160 may generate a display screen for displaying the “claim” and the other categories and also displaying statements and their materials categorized as the individual categories and may control the display device to display the display screen. Additionally, when a claim characteristic value is changed so as to satisfy the condition described above in response to a change of a characteristic value, the display control unit 160 may use any of various methods to display the changed characteristic value and the statement and its materials associated with the changed characteristic value distinguishably (e.g., in a different color) from the other characteristic values and the statements and their materials associated with the other characteristic values.

In the example described above, in response to the presentation of a new statement and its materials (in the example illustrated in FIGS. 13A and 13B, the “warrant (3)”), the level of importance of a previously presented statement and its materials (in the example illustrated in FIGS. 13A and 13B, the “rebuttal (2)”) is changed. The administrator may change the characteristic value of a previously presented statement and its materials even when no new statement or materials are presented. In response to a change of a characteristic value, the calculation unit 140 calculates claim characteristic values by using the updated characteristic value. Then, the display control unit 160 updates the content of the display screen in accordance with the calculated claim characteristic values. That is, the administrator may use claim characteristic values, which are updated in response to a change of the characteristic value of a statement and its materials, to recognize the effect of the change of the characteristic value on the argument.

### Operation of Conference Support System

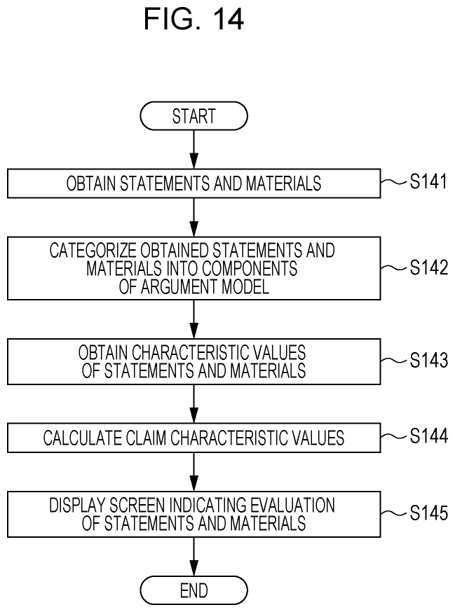

FIG. 14 is a flowchart illustrating the operation of the conference support server 100 according to this exemplary embodiment. The conference support server 100 obtains, using the conference information obtaining unit 110, statements and their materials about an argument (S141). Then, the conference support server 100 categorizes the obtained statements and their materials into components of a predetermined argument model in accordance with positioning information obtained by the positioning information obtaining unit 120 (S142). Through the categorization, the statements and their materials are associated with each other on the basis of the argument model. Then, the conference support server 100 obtains, using the characteristic value data obtaining unit 130, the characteristic values of the statements and their materials (S143), and calculates, using the calculation unit 140, the claim characteristic values of the claim in the argument (S144). Then, in the conference support server 100, the display control unit 160 causes the display unit 320 of the administrator terminal 300 to display a display screen indicating the evaluation of the statements and their materials on which the characteristic values, the claim characteristic values, and the statements and their materials are arranged in accordance with the argument model (S145).

### Modifications

In the conference support server 100 described above, characteristic values are input to the characteristic value data obtaining unit 130 manually by a person such as the conference facilitator or an input operator. Alternatively, information obtained by the operation of the participant terminals 200 by the conference participants may be used to help obtain characteristic values. For example, the operation unit 230 of each of the participant terminals 200 may have an operation button, which is used to input information indicating the degree of agreement. Information on the degrees of agreement may be obtained in accordance with the operation of the operation button by the conference participants. The operation button may be operated such that, for example, each conference participant designates a value of the degree of agreement (e.g., “0” to “1”) corresponding to the degree to which the conference participant agrees and inputs the value (i.e., presses the button). Alternatively, the value of the degree of agreement may be specified in accordance with the number of times the operation button was operated. For example, a degree of agreement of “0.1” may be set in response to pressing the operation button once, a degree of agreement of “0.2” may be set in response to pressing the operation button twice, and a degree of agreement of “1” may be set in response to pressing the operation button ten times. Alternatively, instead of the operation unit 230 being provided with a dedicated operation button, each of the participant terminals 200 may have a function of inputting information indicating the degree of agreement by using application software. Alternatively, the conference support server 100 may provide a web page to accept input of information indicating the degree of agreement, and each conference participant may access the web page by using their participant terminal 200 to input information indicating the degree of agreement. Alternatively, each of the participant terminals 200 may be provided with the input means described above which is operated by a person such as the conference facilitator or an input operator to input the degree of agreement. After that, the input result may be displayed on the participant terminals 200 so that the input result may be corrected by each of the participants.

In the exemplary embodiment described above, the characteristic value data obtaining unit 130 obtains the degrees of agreement of the respective conference participants on each statement and its materials and calculates the sum of the obtained degrees of agreement to determine the degree of agreement on the statement and its materials. Alternatively, the characteristic value data obtaining unit 130 may input a degree of agreement among a plurality of conference participants. For example, each group of conference participants may determine the degree of agreement of the group through discussions, and the conference participants in the group may input the same value by using their participant terminals 200. Alternatively, a value agreed by each group of conference participants may be reported and input. Alternatively, all the conference participants may be regarded as a single group, and all the conference participants may input the same value on the basis of the agreement among the conference participants, or may input a single value on which the conference participants agree.

In the exemplary embodiment described above, obtained statements and their materials are categorized directly into elements (categories) of an argument model. Alternatively, obtained statements and their materials may be processed before being categorized. For example, instead of using obtained statements and their materials as is, the statements and their materials may be summarized to generate a summary in text, and the summary may be categorized into the elements of the argument model. Alternatively, a plurality of statements and their materials may be associated with each other to generate a group, and each group of statements and their materials may be categorized into elements of an argument model. The generation of a summary or the grouping of statements and their materials may be performed by a person such as the administrator or may be performed mechanically. To mechanically generate a summary, any existing technique called extractive summarization or generative summarization may be used to generate a summary. To the generated summary, information may be added that may be used to identify categories of an argument model. For example, words or phrases may be extracted from statements and their materials during the generation of a summary, and a sentence that clarifies a category on the basis of the extracted words or phrases may be added to the generated summary at a specific place. Specifically, for example, when a phrase indicating a warrant for a claim is extracted from statements and their materials that are summarized into a summary, a sentence that clarifies the “warrants” category, such as “a warrant for the xxxx (claim)”, is added to the beginning of the summary. When such information as identifying a category is extracted, statements and their materials may be grouped in accordance with the extracted information.

In the exemplary embodiment described above, the Toulmin model is used as an argument model, by way of example. In this exemplary embodiment, any of various argument models other than the Toulmin model may be used. For example, an argument model based on dialectics may be used. Dialectics involve two modes: verification and deduction of the validity of an ambiguous claim; and “substantiation” of a formal, closed system.

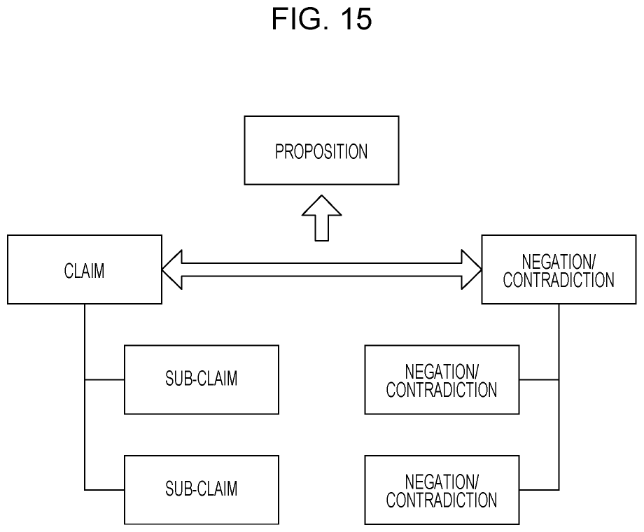

FIG. 15 illustrates an example of an argument model based on dialectics. In dialectical argumentation, first, for an arbitrary controversial claim, a claim negating or contradicting the controversial claim is presented. Then, the percentage of subjective agreements of conference participants on the claim is obtained, and the agreements are collected. If a result of the collection is accepted by the conference participants, a proposition corresponding to the result of the collection is represented as the conclusion. If the result of the collection is not accepted by the conference participants, the claim is broken down into sub-claims on the basis of warrants for the claim, and the sub-claims are argued in a similar way. Specifically, the level of importance and the level of influence of each of the sub-claims are defined. Then, claims negating or contradicting the sub-claims are presented. The percentage of agreements of conference participants on each of the sub-claims is obtained, and the agreements are collected. Then, whether a result of the collection is accepted by the conference participants is evaluated. Subsequently, a claim is recursively broken down and is repeatedly argued until the claim is accepted.

When the argument model described above is applied, the percentage of agreements of conference participants may be obtained by, for example, inputting the percentage of agreements by the administrator using the administrator terminal 300 or inputting the agreements by the conference participants using their participant terminals 200. The degree of claim agreement in this argument model is calculated using, for example, equation (3) below, and the degree of claim certainty in this argument model is calculated using, for example, equation (4) below.

$$\begin{matrix}\frac{{\sum }_{i = 0}^{i = m} ( {\sum }_{j = 0}^{j = n} max ( \frac{{a}_{ij}}{{a}_{ij} + {d}_{ij}} , \frac{{d}_{ij}}{{a}_{ij} + {d}_{ij}} ) ) \times {p}_{i}}{( m + 1 ) \times ( n + 1 ) \times {\sum }_{i = 0}^{i = m} {p}_{i}} & ( 3 ) \\ \frac{{\sum }_{i = 0}^{i = m} ( {\sum }_{j = 0}^{j = n} ( \frac{{a}_{ij}}{{a}_{ij} + {d}_{ij}} - \frac{{d}_{ij}}{{a}_{ij} + {d}_{ij}} ) ) \times {p}_{i}}{( m + 1 ) \times ( n + 1 ) \times {\sum }_{i = 0}^{i = m} {p}_{i}} & ( 4 )\end{matrix}$$

In equations (3) and (4), p denotes the level of importance of a set of undivided claim and negation or contradiction, a denotes the proportion of agreements on the claim, and d denotes the proportion of agreements on the negation or contradiction. Further, (n+1) denotes the number of conference participants (0 to n), and (m+1) denotes the number of sets of undivided claims and negations or contradictions (0 to m). That is, aᵢⱼ represents the proportion of agreement of the i-th (i:0≤i≤m) speaker on the claim in the j-th (j:0≤j≤m) set of undivided claim and negation or contradiction, and dᵢⱼ represents the proportion of agreement of the i-th speaker on the negation or contradiction in the j-th set of undivided claim and negation or contradiction.

While an exemplary embodiment of the present disclosure has been described, the technical scope of the present disclosure is not limited to the exemplary embodiment described above. Various modifications or replacements may be made to the exemplary embodiment of the present disclosure without departing from the technical spirit of the present disclosure, and such modifications or replacements fall within the scope of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a positioning information obtainer that obtains information on positions of statements in an argument;
a level-of-importance obtainer that obtains levels of importance of the statements for a claim in the argument in accordance with the positions of the statements;
a degree-of-agreement obtainer that obtains a degree of agreement indicating a degree to which participants in the argument agree on each of the statements; and
a calculator that calculates a degree of claim agreement of the claim and a degree of claim certainty of the claim from the levels of importance and the degrees of agreement on the statements, the degree of claim agreement indicating a degree to which the participants in the argument agree on the claim, the degree of claim certainty indicating a degree of certainty of the claim.

2. The information processing system according to claim 1, wherein
the positioning information obtainer obtains information on the positions of the statements, the positions of the statements being specified by categorizing the statements into components of a predetermined argument model.

3. The information processing system according to claim 2, further comprising
a categorizer that analyzes the statements and categorizes the statements in accordance with the argument model, wherein
the positioning information obtainer obtains information on the positions of the statements, the positions of the statements being specified by using categorization performed by the categorizer.

4. The information processing system according to claim 3, further comprising
a biometric information obtainer that obtains biometric information of the participants in the argument, wherein
the categorizer corrects categorization of the statements on the basis of the biometric information obtained by the biometric information obtainer.

5. The information processing system according to claim 1, further comprising
a display that indicates the positions of the statements in the argument and that displays the degree of claim agreement and the degree of claim certainty calculated by the calculator.

6. The information processing system according to claim 5, wherein
the display displays the degree of claim agreement and the degree of claim certainty when the degree of claim agreement and the degree of claim certainty satisfy a predetermined condition.

7. The information processing system according to claim 6, wherein
in response to a new statement in the argument, the positioning information obtainer, the level-of-importance obtainer, the degree-of-agreement obtainer, and the calculator update the degree of claim agreement and the degree of claim certainty on the basis of the new statement, and
the display displays the updated degree of claim agreement and the updated degree of claim certainty when the degree of claim agreement, the degree of claim certainty, the updated degree of claim agreement, and the updated degree of claim certainty satisfy a predetermined condition.

8. The information processing system according to claim 1, further comprising
a change unit that changes, in response to receipt of a user input, at least one of the level of importance and the degree of agreement on at least one of the statements, the level of importance of the at least one of the statements being obtained by the level-of-importance obtainer, the degree of agreement on the at least one of the statements being obtained by the degree-of-agreement obtainer, wherein
the calculator calculates the degree of claim agreement and the degree of claim certainty by using the changed at least one of the level of importance and the degree of agreement.

9. The information processing system according to claim 8, further comprising
an output unit that outputs, when at least one of the degree of claim agreement and the degree of claim certainty calculated by the calculator changes in response to a change of at least one of the level of importance and the degree of agreement on at least one of the statements by the change unit, the argument in which the statements have been made, the statements, the changed at least one of the degree of claim agreement and the degree of claim certainty, and the changed at least one of the level of importance and the degree of agreement in association with one another.

10. An information processing system comprising:
a categorizer that categorizes a plurality of statements in an argument into components of a predetermined argument model;
a characteristic value obtainer that obtains characteristic values of the plurality of statements;
an associator that associates the plurality of statements with each other in accordance with the components into which the plurality of statements are categorized by the categorizer;
a calculator that calculates a claim characteristic value by using the characteristic values of the plurality of statements and a result of associating the plurality of statements with each other, the claim characteristic value indicating a characteristic of a claim in the argument; and
a display that displays the plurality of statements and the claim related to the claim characteristic value when the claim characteristic value satisfies a predetermined condition.

11. The information processing system according to claim 10, wherein
the display displays the plurality of statements and the claim related to the claim characteristic value when the claim characteristic value is a biased value.

12. The information processing system according to claim 10, wherein
the display displays the plurality of statements and the claim related to the claim characteristic value when the claim characteristic value is less than a predetermined threshold value.

13. The information processing system according to claim 10, wherein
the display displays, in an argument in which one of one or more statements made in connection with a first claim is made as a second claim different from the first claim, a claim characteristic value of the second claim in association with the one or more statements made in connection with the first claim.

14. The information processing system according to claim 10, further comprising
a change unit that changes, in response to receipt of a user input, at least one of the characteristic values obtained by the characteristic value obtainer, wherein
the calculator calculates the claim characteristic value by using the changed at least one of the characteristic values.

15. The information processing system according to claim 14, wherein
when the claim characteristic value calculated by the calculator changes in response to a change of at least one of the characteristic values by the change unit,
the display displays the claim in the argument in which the plurality of statements have been made, the plurality of statements, the changed at least one of the characteristic values, and the changed claim characteristic value in association with one another.

16. The information processing system according to claim 14, wherein
when the claim characteristic value calculated by the calculator changes in response to a change of at least one of the characteristic values by the change unit and when the change of the claim characteristic value before and after the change of the at least one of the characteristic values satisfies a predetermined condition,
the display displays the changed at least one of the characteristic values and one or more statements related to the changed at least one of the characteristic values among the plurality of statements in a distinguishable manner from characteristic values other than the changed at least one of the characteristic values and statements related to the other characteristic values among the plurality of statements.

17. The information processing system according to claim 10, wherein
in response to a new statement in the argument, the categorizer, the characteristic value obtainer, the associator, and the calculator update the claim characteristic value and at least one of the characteristic values on the basis of the new statement, and
when a change in the claim characteristic value before and after update of the claim characteristic value satisfies a predetermined condition, the display displays the updated at least one of the characteristic values and one or more statements related to the updated at least one of the characteristic values among the plurality of statements in a distinguishable manner from characteristic values other than the updated at least one of the characteristic values and statements related to the other characteristic values among the plurality of statements.

18. A non-transitory computer readable medium storing a program causing a computer to execute a process for information processing, the process comprising:
categorizing statements in an argument into components of a predetermined argument model, and associating the statements with each other in accordance with the components into which the statements are categorized;
obtaining characteristic values of the statements;
calculating a claim characteristic value by using the characteristic values of the statements and a result of associating the statements with each other, the claim characteristic value indicating a characteristic of a claim in the argument; and
displaying the statements and the claim related to the claim characteristic value on a display when the claim characteristic value satisfies a predetermined condition.

19. An information processing method comprising:
categorizing statements in an argument into components of a predetermined argument model, and associating the statements with each other in accordance with the components into which the statements are categorized;
obtaining characteristic values of the statements;
calculating a claim characteristic value by using the characteristic values of the statements and a result of associating the statements with each other, the claim characteristic value indicating a characteristic of a claim in the argument; and
displaying the statements and the claim related to the claim characteristic value on a display when the claim characteristic value satisfies a predetermined condition.
